(19) United States
(12) Patent Application Publication
(10) Pub. No.: US 2012/0118671 A1
(43) Pub. Date: May 17, 2012

(54) Vehicle Lift Device

(76) Inventor: Francesco Fiorese, Albignasego (IT)

(21) Appl. No.: 13/297,812

(22) Filed: Nov. 16, 2011

(30) Foreign Application Priority Data
May 19, 2009 (IT) VI2009A000117

(51) Int. Cl. B66F 7/28

(52) U.S. Cl. 187/204

(57) ABSTRACT

Provided for is a vehicle lifting device, of the type adapted to allow the demounting and the re-mounting of the lower parts of the body and/or of the mechanical parts of the vehicle, said lifting device (2) being provided with liftable platforms (3); said lifting device is characterized in that the lifting and the lowering of said liftable platforms occurs by exploiting the same energy that moves the lifting device, hence moving the aforementioned lifting device allows also actuating the mechanism of opening and closure of each of the liftable platforms (3), which provides for the lifting/opening and lowering/closure of said platforms.

The present finding regards a vehicle lift device, according to the general part of claim 1.

As it is well known to those specialized in the field of vehicle repair and in particular bodywork repair sector, due to the high costs of labour and spare parts it is convenient to repair only vehicles not seriously damaged.

In particular motor vehicles, which constitute about 80% of the total of the reparations and which enter in the repair workshops or in bodywork repair workshop on “their wheels”, require, in order to contain the cost of intervention, the use of constructively simple and quick to use equipments.

For such purpose, a vehicle space is required, in a determinant manner, provided with a multifunctional lifting device, so called due to the fact that it can serve both as a work bench and as a simple lifting device and which allows demounting and re-mounting the lower parts both of the body and of the mechanical parts of the vehicle as well as the diagnosis and/or the straightening.

The use of a multifunctional lifting device allows considerably labour time savings, given that it avoids of having to move the damaged vehicle from one equipped workplace for a specific function (as a lifting device for demounting), to another workplace, equipped for a different function (for example a straightening bench).

As of the current state of the art lifting devices with rubber pads to be positioned “beneath the door”, which however require considerable amount of time before performing the lifting, in that the operator should first position the rubber pads on the arms of the lifting device and thus verify whether they are centred in the lifting points indicated by the manufacturer of the vehicle are very common; the entirety is associated to a high degree of discomfort for the operator who is required to bend at least four times before pressing the “start” of lifting, given that the vehicle is positioned at the ground level.

Still according to the state of the art, lifting devices provided with platforms adapted to lift at the wheels of the vehicle, which are more rapid and comfortable, in that it is sufficient to move the vehicle on the platforms and lift it., are also very common

Practically the lifting on platforms on which the wheels lie, which is to be preferred with respect to the lifting device with pads “beneath the door”, reveals the drawback of not being able to space the vehicle from the lifting device for creating a space where to be able to operate in a quick and comfortable manner.

Most of the body works provides for the free wheels and/or the vehicle spaced from the upper plane of the lifting device so as to be able to use equipments, fastening templates, measurement instruments, as well as for performing the demounting and the re-mounting of the lower protections, which are still the most common in the vehicles of the latest design; for these works the body lifting devices with pads, though with the aforementioned drawbacks, are preferred up to date.

Alternatively, sometimes, in the bodywork repair workshops workshop lifting devices are used so as to be able to perform the reparation, replacement or mechanical works in the lower part of the vehicle but such repairing lifting devices, if of the scissor-like type with separate platforms, leave the central passage free, while they occupy the side areas; if, instead, they are of the type with two columns, they occupy the entire external side space, hence are both not easy to use.

An object of the present finding is that of providing a lifting device capable of combining the speed and the comfort of freeing the wheels and/or spacing the lower part of the vehicle from the lifting device.

A further object of the finding is hat of providing a lifting device capable of being differentiated from the conventional systems due to the possibility of spacing the lower part of the vehicle from the upper deck of the lifting device, maintaining the wheels still resting on the platforms in a synchronized manner, both when opening the platforms wheels and with the same open, thus avoiding the occurrence of flexions and/or torsions of the vehicle which, at times, are considerable as, for example, in the SUVs, and generally in the four wheel drive vehicles, due to the considerable weight of the engine and of the mechanical elements.

Specifically, the first object of the present invention is that of providing a lifting device, adapted for devices for lifting vehicles with two or more wheels, capable of allowing the operator to comfortably perform the following operations:
measuring a repaired vehicle or vehicle to be repaired maintaining it aligned without flexions;
performing the measurement diagnosis with the maximum rapidity and safety in that the vehicle, although it is lifted, however rests on the wheels and thus reflects the same state as when on the road;
demounting and re-mounting the lower protections.

Furthermore, a further object of the finding is that of providing a lifting device which differs from the conventional systems due to the possibility of reaching, using the perimetral platforms adapted for lifting the vehicle on wheels, work heights up to about 1900 mm. (measured between the floor and the resting plane of the wheels on the aforementioned perimetral platforms) using the mobile platform with low lift.

Such objects are attained by providing a lifting device which is provided, at the ends, with liftable/openable and reclosable platforms, arranged at the wheels of the vehicle, said perimetral platforms being openable and re-closable without requiring using external circuits, such as oil hydraulic actuators, but, advantageously, by exploiting the very same energy that moves the lifting device; specifically, moving the lifting device allows actuating a mechanism of opening, integrated in each of the platforms, which provides for the opening and closure of said platforms.

The characteristics of the invention shall be better understood and defined by means of the description of some possible embodiments, provided by way of non-limiting example, with reference to the attached drawings, where:

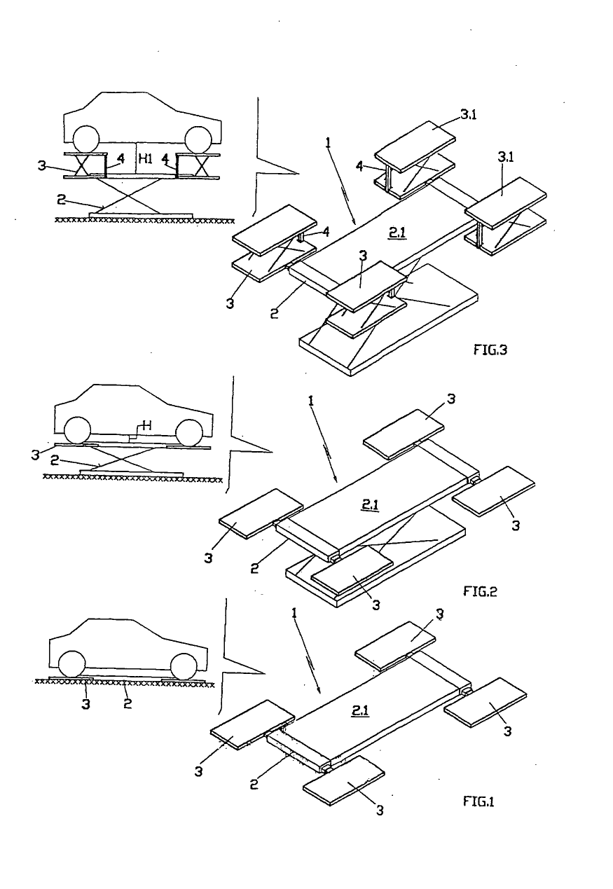

FIGS. 1-3 (table I) represent the operating positions the lifting device can assume according to the finding;

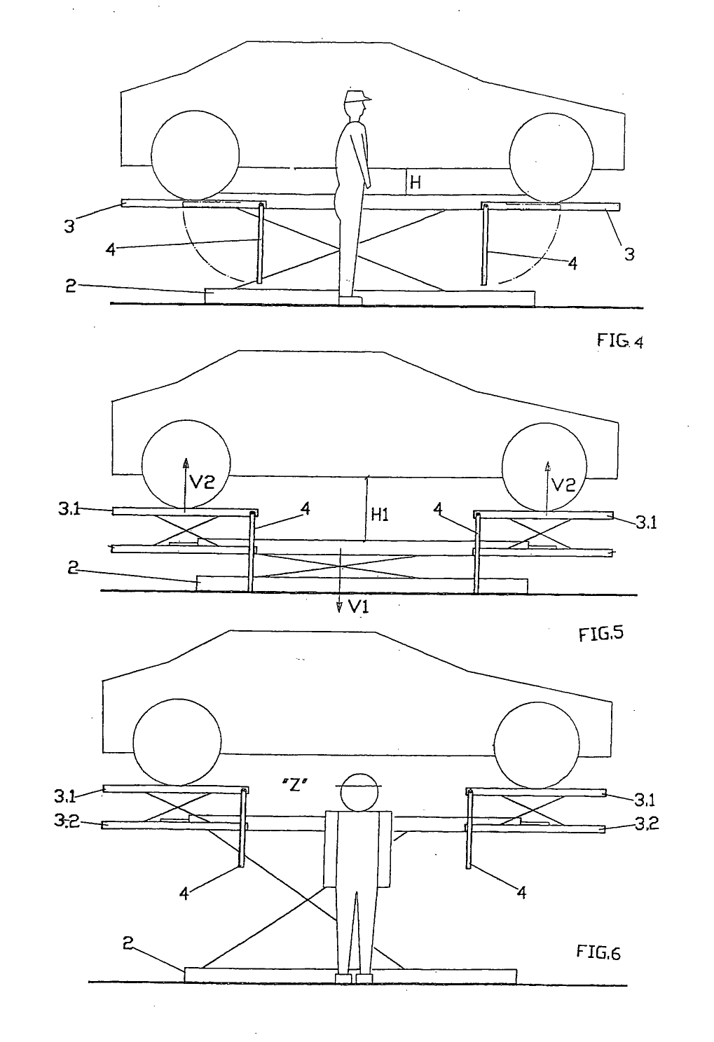

FIGS. 4-6 (table II) represent the steps of lifting and opening the openable and re-closable platforms according to the finding;

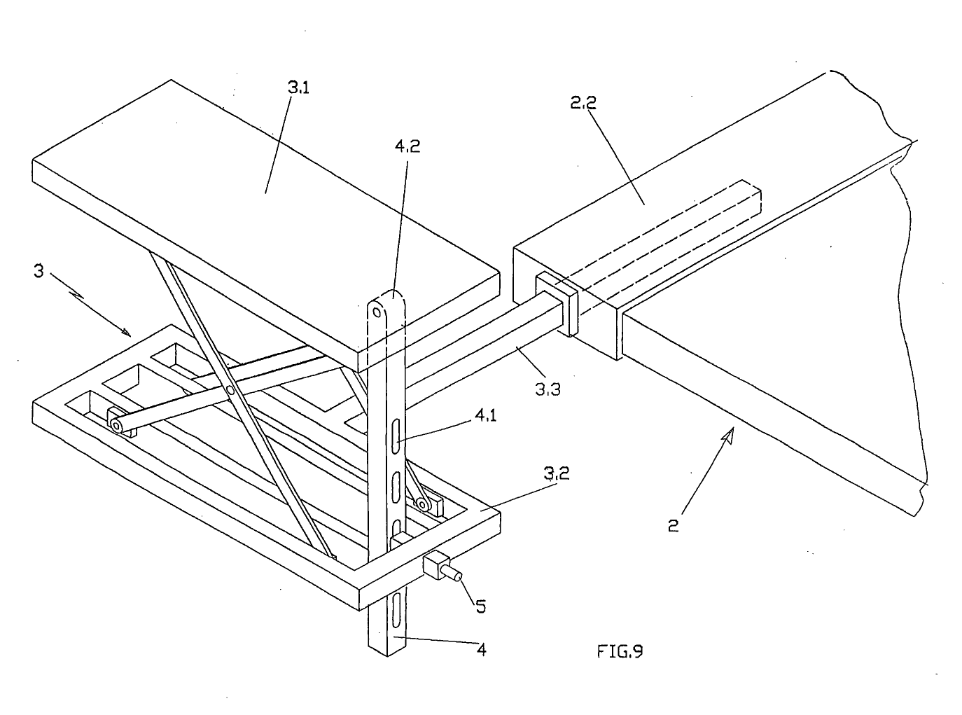

FIGS. 7-8 (table III) represent axonometric views of two embodiments of the lifting device according to the finding.

FIG. 9 (table IV) represents the perspective view of the liftable/openable/re-closable platform.

As observable in the figures, the lifting device according to the finding, indicated in its entirety with reference 1, comprises a central lifting device, of the per se known type, indicated with reference 2, which is provided with four perimetral liftable/openable platforms/re-closable, indicated with reference 3, applied on the four sides of the upper plane 2.1 of the lifting device 2 and arranged at the wheels of the positioned vehicle.

The four perimetral platforms 3, when closed, are substantially co-planar with the plane 2,1 hence the central lifting device 2 operates, both when it is completely closed (see FIG. 1) at the level of the floor, and, when it is lifted (see FIG. 2), like a normal lifting device and in these situations the lower part of the vehicle is spaced by a value “H” from the aforementioned upper plane 2.1 of the lifting device 2.

On the contrary, as observable in FIG. 3, with the opening of the four perimetral platforms 3, the vehicle is further lifted so as to increase the space “H1” between the upper plane 2.1 and the part and the lower part of the vehicle, which is what is intended to be obtained with the finding.

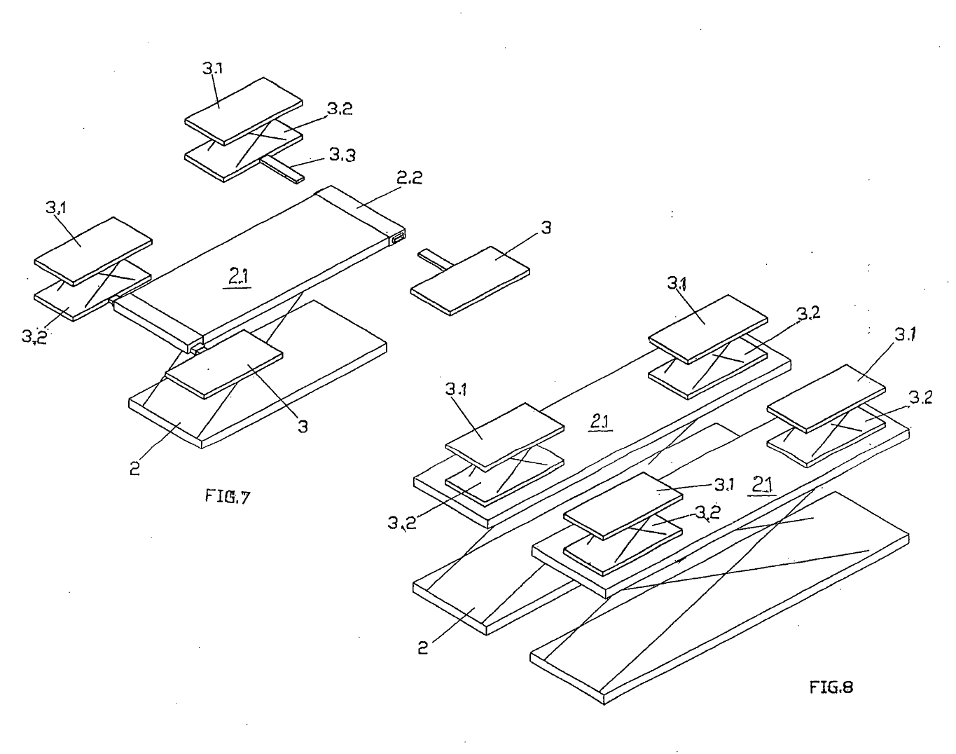

The opening of each of the four platforms 3 is obtained by means of a lifting mechanism substantially represented by a rod 4, projecting below the four lower planes 3.2 which compose the aforementioned platforms and constrained to the upper deck 3.1 thereof (see FIG. 5), or to the parts in movement during the opening and closure of each platform 3.

With such construction solution, from the work position with the vehicle maintained lifted through the central lifting device 2 (see FIG. 4) when the aforementioned lifting device is lowered, the end of the rod 4 rests on the ground hence, continuing the lowering—closure of the aforementioned lifting device (see arrow V1), the aforementioned rods 4 cause the opening of the scissors of the perimetral platforms 3 to which they are associated, i.e. the lifting of the upper decks 3.1, forming a lifting of the vehicle which is spaced from the upper deck 2.1 of the central lifting device by a height “H1” (see FIG. 5).

Hereinafter, with the subsequent lifting of the central lifting device 2, the vehicle is lifted in a second work position (see FIG. 6) wherein, being increased the space “Z” beneath the vehicle, the operator is allowed to perform the operations of repairing and replacing the lower parts in a very facilitated condition.

The rods 4 can be connected by means of hinges to the upper decks 3.1 or to the other parts of lifting mechanisms of the openable and reclosable perimetral platforms 3.

From a constructional point of view, the platforms 3 can be applied on all types of lifting devices available in the market, ranging from lifting devices with single platform, to lifting devices with double platform, up to the lifting devices provided with the straightening bench.

For example the platforms 3 are applied in the normal lifting devices with single platform, by providing longitudinal members 3.3 conflected to each lower deck 3.2, which end up fitted in the guides 2.2, present on the lifting device (see FIG. 7), or in the scissor-like separate lifting devices, by positioning the aforementioned platforms directly on the upper decks (see FIG. 8), or still in the lifting devices normally provided for in the straightening benches.

From a constructional point of view, the lifting mechanism consists of the rod 4, hinged on the upper deck 3.1 or on a point of the levers of the mechanism, so that when the upper deck 3.1 is lowered, said rod lies in horizontal position and it is also contained in the structure of the lower deck 3.2. (see FIG. 1).

In a subsequent step, after performing the lifting of the upper deck 2.1 of the main lifting device (see FIG. 2), the operator frees rod 4, contained in a guide obtained in the lower deck 3.2, from the horizontal position thereof, so that, under gravity, said rod is arranged in vertical position, (see FIG. 4).

The lifting of the upper deck 3,1 is obtained by lowering the deck 2.1 of the main lifting device so as to rest the rod 4 on the floor which, by means of the lifting mechanism of the porimetral platform 3, with the further lowering of the deck 2.1 aforementioned, causes the complete or partial lifting of the upper deck 3.1 (see FIG. 5).

Practically, the complete or partial lifting of the upper deck 3.1 of the platform 3 is allowed by the particular configuration of the lifting mechanism, which from a constructional point of view, besides the levers, is provided with the rod 4, connected to the deck 3.1 by means of a hinge 4.2, provided with slits or slots 4.1 in which a ratchet 5 is engaged, which is actuated by the operator.

The distance between the upper deck 3,1 and the lower deck 3.2 is thus determined by the number and by the position of the aforementioned slits 4.1 with respect to the insertion position of the ratchet 5 (see FIG. 9).

One of the advantages of the present finding lies in the fact that the lifting device according to the invention, given that it lifts less than the lifting devices of the known type; will have a smaller length than the aforementioned ones, leaving the operator a greater space, beneath, in front and behind him/her.

The finding thus obtained can be subjected to numerous modifications and variants, as well as the details thereof which can be replaced by technically equivalent elements, all falling within the inventive concept defined in the following claims.

1. A vehicle lift device of the type adapted to attain the demounting and the remounting of the lower parts of the vehicle body and/or of the mechanical parts of the vehicle as well as the diagnosis and/or straightening thereof, comprising a central lifting device (2), such as a single platform lifting device, a double platform lifting device, a scissor-like lifting device with straightening bench or of any other type, which is provided with liftable/openable and reclosable platforms (3), where each of said liftable/openable and reclosable platforms (3) is provided with a lifting mechanism comprising a rod (4) and where said platforms (3), arranged at the wheels of the positioned vehicle, when closed, are substantially coplanar with an upper deck (2.1) of the central lifting device (2), hence the complete lifting device (1) operates, both when it is completely closed, i.e. arranged at the level of the floor, and when it is lifted/open, like a normal lifting device and in these situations the lower part of the vehicle is spaced by a value (H) from the upper deck (2.1) of the lifting device (2), while, on the contrary, with the opening of the liftable/openable and reclosable platforms (3), the vehicle is further lifted so as to increase the space (H1) between the upper deck (2.1) and the lower part of the vehicle, said lifting device being characterized in that the opening and the closure of the liftable platforms (3) occurs by exploiting the movement of the upper deck (2.1) hence, moving the aforementioned upper deck (2.1), allows actuating the opening and closure mechanism of each of the liftable/openable and reclosable platforms (3), through the rod (4), integrated in each of the aforementioned liftable/openable and reclosable platforms (3), which provides for the opening and closure of said liftable/openable and reclosable platforms.

2. The lifting device according to claim 1, characterized in that the movement of the mechanism of opening and closure of each of the platforms (3) is obtained by means of the rod (4), which in non-use conditions is contained within the platforms (3), while in operative step it projects at the lower part from each lower deck (3.2) of the platforms (3) and it is constrained to an upper deck (3.1) thereof or the mobile parts during the lifting or the lowering of each upper deck (3.1), so that, from the work position, with the vehicle kept lifted through the central lifting device (2), when the aforementioned lifting device is lowered, the end of the rod (4) rests on the ground hence, continuing the lowering or closure of the aforementioned lifting device, the aforementioned rod (4) causes the opening of the openable and reclosable platform(3), to which said rod (4) is associated, i.e. there occurs the lifting of the upper deck (3.1) thereof, with the result of obtaining the lifting of the vehicle, which is spaced (H1) from the upper deck (2.1) of the central lifting device (2).

3. The lifting device according to claim 2, characterized in that the rod (4) is connected to the upper deck (3.1) of the platform (3) by means of a hinge (4.2), the rod being provided with a series of slits or slots (4.1) in which a ratchet (5) is engaged, which is actuated by an operator; thus the distance between the upper deck (3.1) and the lower deck (3.2) is determined by the number and by the position of the aforementioned slits (4.1) with respect to the insertion position of the ratchet (5).

4. The lifting device according to claim 1, characterized in that the platforms (3) are applied in the normal vehicle lifting devices with single platform, providing them with longitudinal members (3.3), which end up fitted in the guides (2.2), located on the platforms of the central lifting device (2).

5. The lifting device according to claim 1, characterized in that in the lifting devices of the separate scissor type, the platforms (3) are positioned directly on the upper decks of the lifting device.

6. The lifting device according to claim 1, characterized in that it is of the type normally provided on the straightening benches.

7. The lifting device according to claim 1, characterized in that it is used for lifting vehicles with two or more wheels.
